(19) United States
(12) Patent Application Publication
(10) Pub. No.: US 2013/0088754 A1
(43) Pub. Date: Apr. 11, 2013

(54) IMAGE FORMING SYSTEM, IMAGE FORMING DEVICE, NON-TRANSITORY COMPUTER READABLE MEDIUM, AND IMAGE FORMING METHOD

(71) Applicants: Takeshi ICHIMURA, Kanagawa (JP); Makoto NISHIMURA, Tokyo (JP)

(72) Inventors: Takeshi ICHIMURA, Kanagawa (JP); Makoto NISHIMURA, Tokyo (JP)

(73) Assignee: FUJI XEROX CO., LTD., Tokyo (JP)

(21) Appl. No.: 13/596,752

(22) Filed: Aug. 28, 2012

(30) Foreign Application Priority Data
Oct. 11, 2011 (JP) 2011-224326

(51) Int. Cl. G06K 15/02

(52) U.S. Cl. 358/1.16

(57) ABSTRACT

Provided is an image forming system including plural image forming devices that form an image, each including: a storage unit that stores user identification information for identifying users and image data that represents an image in correlation, a receiving unit that receives the user identification information of any of the users, a first acquiring unit that acquires image data correlated with the user identification information from the storage unit included in the subject device when the image data is stored in the storage unit, a second acquiring unit that acquires image data correlated with the user identification information and stored in the storage unit included in another image forming device different from the subject device when the first acquiring unit is unable to acquire the image data, and an image forming unit that forms an image corresponding to the image data acquired by the first or second acquiring unit.

### CROSS-REFERENCE TO RELATED APPLICATIONS

This application is based on and claims priority under 35 USC 119 from Japanese Patent Application No. 2011-224326 filed Oct. 11, 2011.

### BACKGROUND

1. Technical Field

The invention relates to an image forming system, an image forming device, a non-transitory computer readable medium, and an image forming method.

2. Related Art

A technique of enabling an image designated by a user to be printed using any one of plural image forming devices connected to a network is known.

### SUMMARY

According to an aspect of the invention, there is provided an image forming system including plural image forming devices that form an image, wherein each of the image forming devices includes: a storage unit that stores user identification information for identifying users and image data that represents an image in correlation; a receiving unit that receives an input of the user identification information of any of the users; a first acquiring unit that acquires image data correlated with the user identification information received by the receiving unit from the storage unit included in the subject device when the image data is stored in the storage unit; a second acquiring unit that acquires image data which is correlated with user identification information received by the receiving unit and which is stored in the storage unit included in another image forming device different from the subject device when the first acquiring unit is unable to acquire the image data; and an image forming unit that forms an image corresponding to the image data acquired by the first acquiring unit or the second acquiring unit.

### BRIEF DESCRIPTION OF THE DRAWINGS

Exemplary embodiments of the present invention will be described in detail based on the following figures, wherein:

FIG. 1 is a block diagram illustrating a configuration of an image forming system;

FIG. 2 is a block diagram illustrating a hardware configuration of a. communication terminal;

FIG. 3 is a block diagram illustrating a hardware configuration of an image forming device;

FIG. 4 is a diagram illustrating print data;

FIG. 5 is a block diagram illustrating a hardware configuration of an index server;

FIG. 6 is a diagram illustrating index data;

FIG. 7 is a block diagram, illustrating a functional configuration of the image forming system;

FIG. 8 is a sequence diagram illustrating the operation of the image forming system;

FIG. 9 is a diagram illustrating an example of a list of print data displayed on the image forming device; and

FIG. 10 is a diagram illustrating an example of a list of print data displayed on the image forming device.

### DETAILED DESCRIPTION

### Exemplary Embodiment

Hereinafter, an exemplary embodiment of the invention will be described with reference to the drawings.

### Configuration

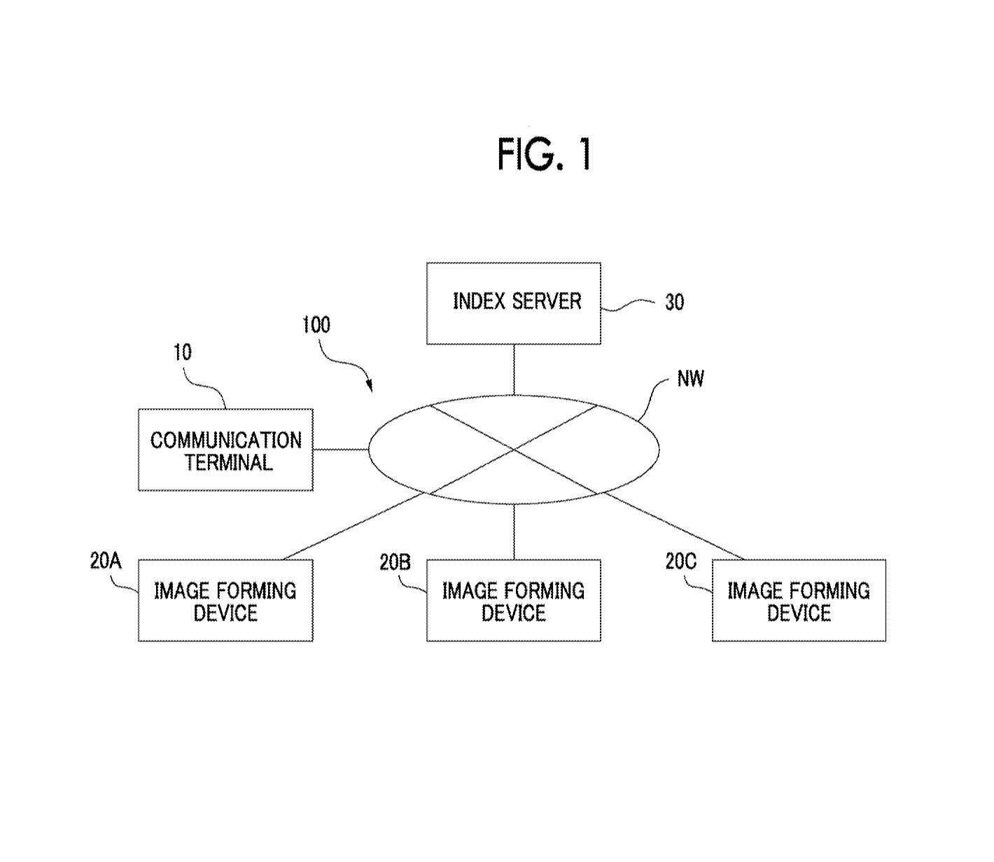

FIG. 1 is a block diagram illustrating the configuration of an image forming system 100 which is an exemplary embodiment of the invention. The image forming system 100 includes a communication terminal 10, image forming devices 20A, 20B, and 20C, an index server 30, and a network NW. When it is not necessary to distinguish the image forming devices 20A, 20B, and 20C, these image forming devices will be referred to as an image forming device 20 by omitting the characters attached to the end of the reference numerals. Moreover, the number of image forming devices 20 and communication terminals 10 is not limited to that illustrated in FIG. 1. The network NW is a communication network including a mobile communication network such as a mobile phone network or a wireless local area network (LAN) and a fixed communication network such as the Internet.

The communication terminal 10 is a communication terminal capable of communicating with the image forming device 20, such as, for example, a wireless terminal capable of connecting to a mobile phone and a wireless LAN, or a personal computer (PC) having a communicating function. In FIG. 1, the communication terminal 10 is a personal computer (PC), for example. The image forming device 20 is an electrophotographic printer, for example. The image forming device 20 includes a storage portion that stores print data transmitted from the communication terminal 10. Here, the print data is data regarding a printing process that the user has instructed using the communication terminal 10 and includes a user ID for identifying the user, image data to be printed, time information, and the like. Here, printing means forming of an image according to an electrophotographic method. The index server 30 is a server device that stores information for identifying the image forming device 20 which each user has designated as a storage destination of the print data in correlation with the user ID. The information for identifying the image forming device 20, namely the device identification information is the name allocated to each of the image forming devices 20 and address information such as an Internet protocol (IP) address.

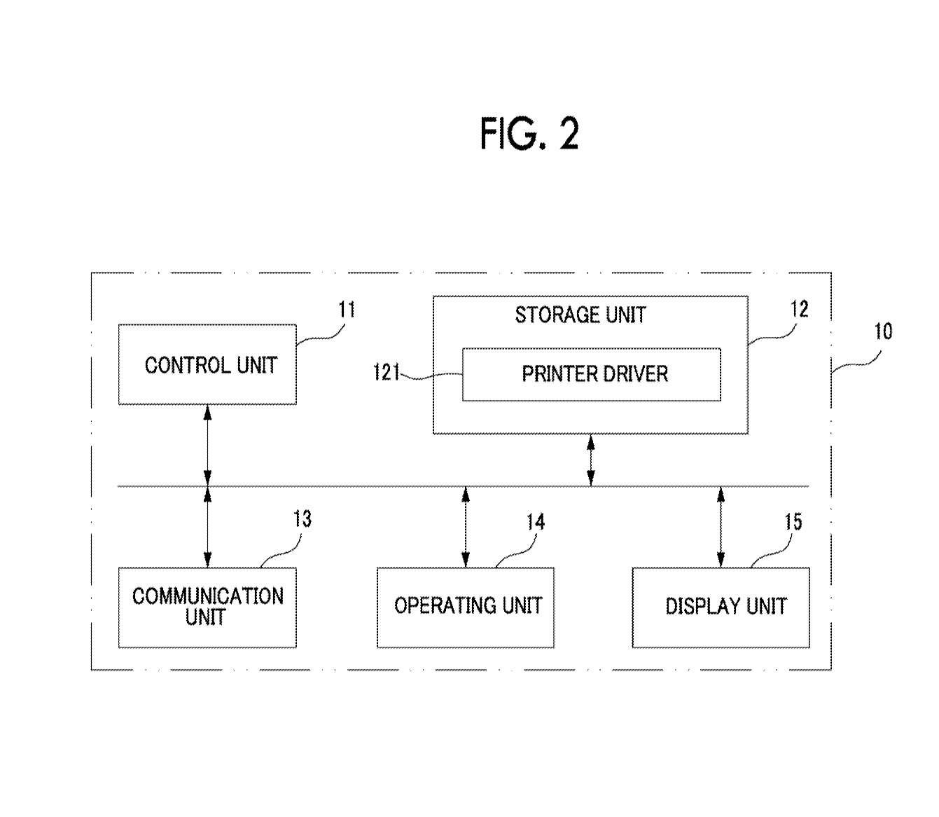

FIG. 2 is a block diagram illustrating the hardware configuration of the communication terminal 10. The communication terminal 10 includes a control unit 11, a storage unit 12, a communication unit 13, an operating unit 14, and a display unit 15. The respective units are electrically connected by a bus. The control unit 11 includes a central processing unit (CPU), a read only memory (ROM), and a random access memory (RAM). The CPU controls the respective units connected to the control unit 11 by executing a control program stored in the ROM or the storage unit 12. The storage unit 12 is a storage device such as a hard disk, for example, and stores a control program or a printer driver 121, for example. The printer driver 121 is a program having a function of controlling the image forming device 20.

The communication unit 13 performs communication with the image forming device 20 under the control of the control unit 11. The operating unit 14 includes a mouse and plural keys for receiving a clicking operation and supplies a signal corresponding to the content of the operation to the control unit 11 when the mouse or the keys are operated by the user. The control unit 11 determines the content of the operation based, on the signal and. performs processing. The display unit 15 includes a display such as a liquid crystal display and a memory such as a video random access memory (VRAM) and displays various images on the liquid crystal display under the control of the control unit 11.

In the printer driver 121, a user ID and spooler information are set in advance in correlation. The spooler information is information that represents a storage location at which the print data transmitted from the communication terminal 10 is stored. The spooler information includes address information such as an IP address allocated to each of the image forming device 20 and the name of each of the image forming devices 20. For example, in the printer driver 121, a user ID “user01,” an IP address “192.168.227.101” allocated to the image forming device 20B, and a name “A001” allocated to the image forming device 20B are set in correlation. The user may change the spooler information set to the printer driver 121 using the operating unit 14.

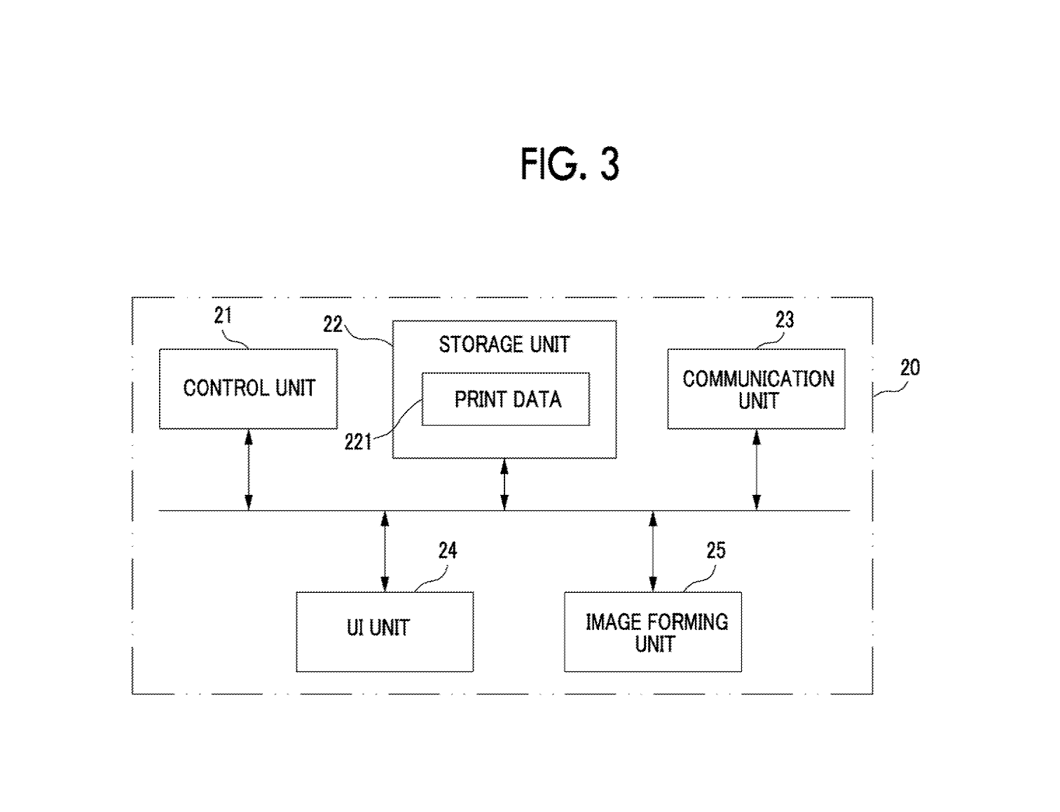

FIG. 3 is a block diagram illustrating the hardware configuration of the image forming device 20. The image forming device 20 is configured as a computer that includes a control unit 21, a storage unit 22, a communication unit 23, a user interface (UI) unit 24, and an image forming unit 25. The respective units are electrically connected by a bus. The control unit 21 includes a CPU, a ROM, and a RAM. The CPU controls the respective units connected to the control unit 21 by executing a control program stored in the ROM or the storage unit 22. The storage unit 22 is a storage device such as a hard disk, for example, and stored a control program and print data 221, for example. The print data 221 is print data that is received from the communication terminal 10. The communication unit 23 performs communication with the communication terminal 10 and the index server 30 under the control of the control unit 21. The UI unit 24 includes a touch screen and keys, for example. The UI unit 24 supplies a signal corresponding to the content of an operation input by the user to the control unit 21. The control unit 21 determines the content of the operation based on the signal and executes a printing process or displays an image on the touch screen. The image forming unit 25 is an example of an image forming unit that forms an image corresponding to the image data on a sheet.

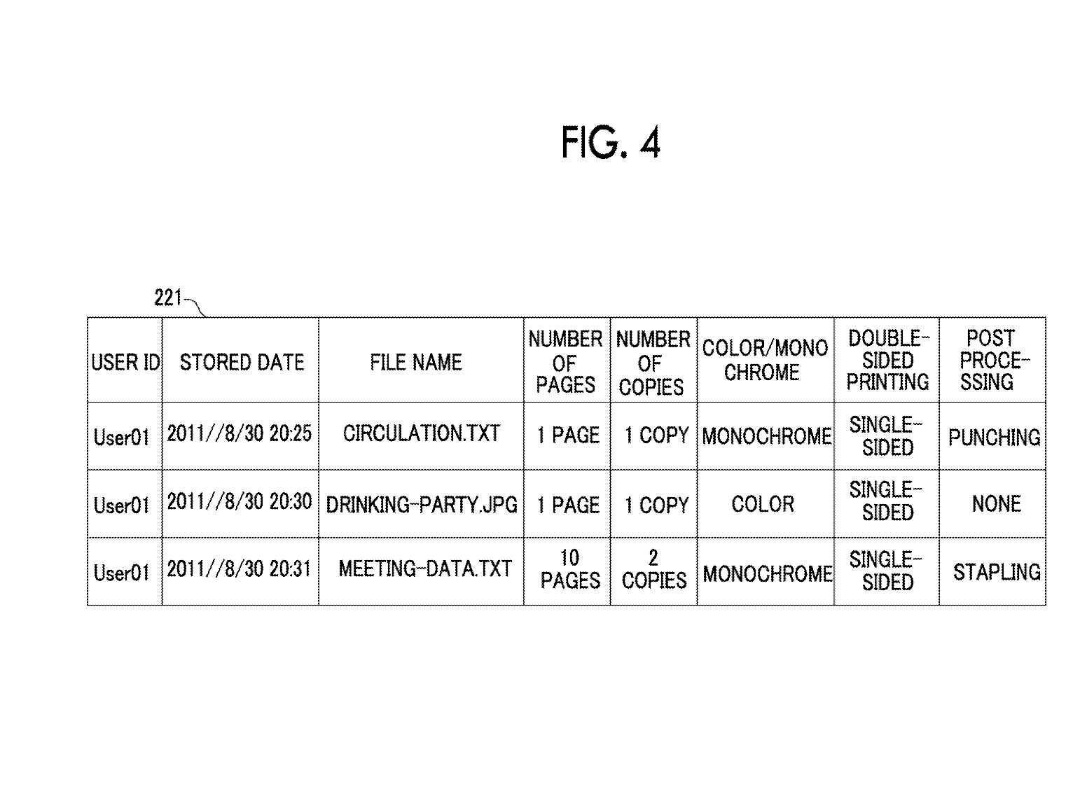

FIG. 4 is a diagram illustrating the print data 221. The print data 221 includes plural data items including “user ID,” “stored date,” “file name,” “number of pages,” “number of copies,” “indication of color/monochrome,” “presence of double-sided printing,” and “post-processing.” The print data 221 may include another item of information. The “user ID” is a user ID of a user that has instructed a printing process using the communication terminal. The “stored date” is the date when the print data is stored in the storage unit 22, namely time information that represents the date when the print data is stored in the image forming device 20, The “file name” represents a file name of print target image data included in the print data. The “number of pages” represents the number of pages of the print target file. The “number of copies” represents the number of copies to be printed. The “indication of color/monochrome” represents whether printing will be performed in colors or monochrome. The “presence of double-sided printing” represent whether double-side printing or single-sided printing will be performed. The “post-processing” represents post-processing that is to be performed on a printed sheet. Besides the above, the print data also includes print target image data itself represented by the “file name.” FIG. 4 illustrates the content of the print data 221 stored in the storage unit 22B of the image forming device 20B, in which three items of print data for the user ID of “USER01” are stored in the image forming device 20B.

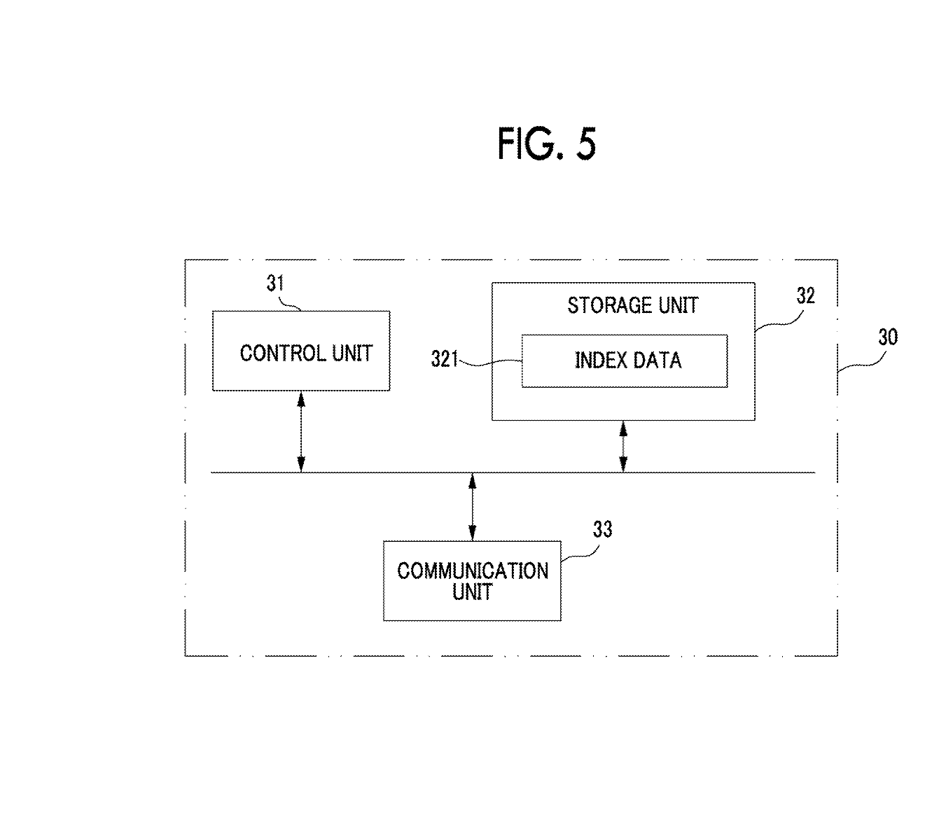

FIG. 5 is a block diagram illustrating the hardware configuration of the index server 30. The index server 30 is configured, as a computer that includes a control unit 31, a storage unit 32, and a communication unit 33. The respective units are electrically connected by a bus. The control, unit 31 includes a CPU, a ROM, and a RAM, The CPU controls the respective units connected to the control unit 31 by executing a control program stored in the ROM or the storage unit 32. The communication unit 33 performs communication with the image forming device 20 under the control of the control unit 31. The storage unit 32 is a storage device such as a hard dish, for example, and stores a control program and index data 321, for example.

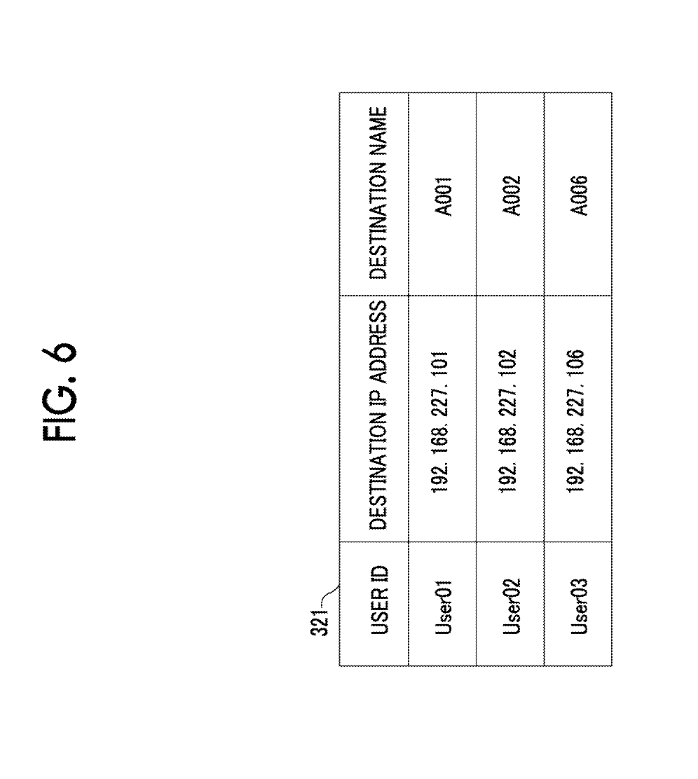

FIG. 6 is a diagram illustrating the index data 321. The index data 321 includes plural items including a user ID, a storage destination IP address, and a storage destination name. The user ID is the same as described above. The storage destination IP address is an IP address allocated to the image forming device 20 that includes a storage portion of the print data transmitted from the communication terminal 10 by the operation of the user. The storage destination name is the name allocated to the image forming device 20. In the index data 321, a user ID, a storage destination IP address, and a storage destination name are described in correlation with respect to plural users. The storage destination IP address and the storage destination name correlated with a certain user ID have the same content as the spooler information set to the printer driver 121 stored in the storage unit 12 of the communication terminal 10 that is operated by the user of the user ID.

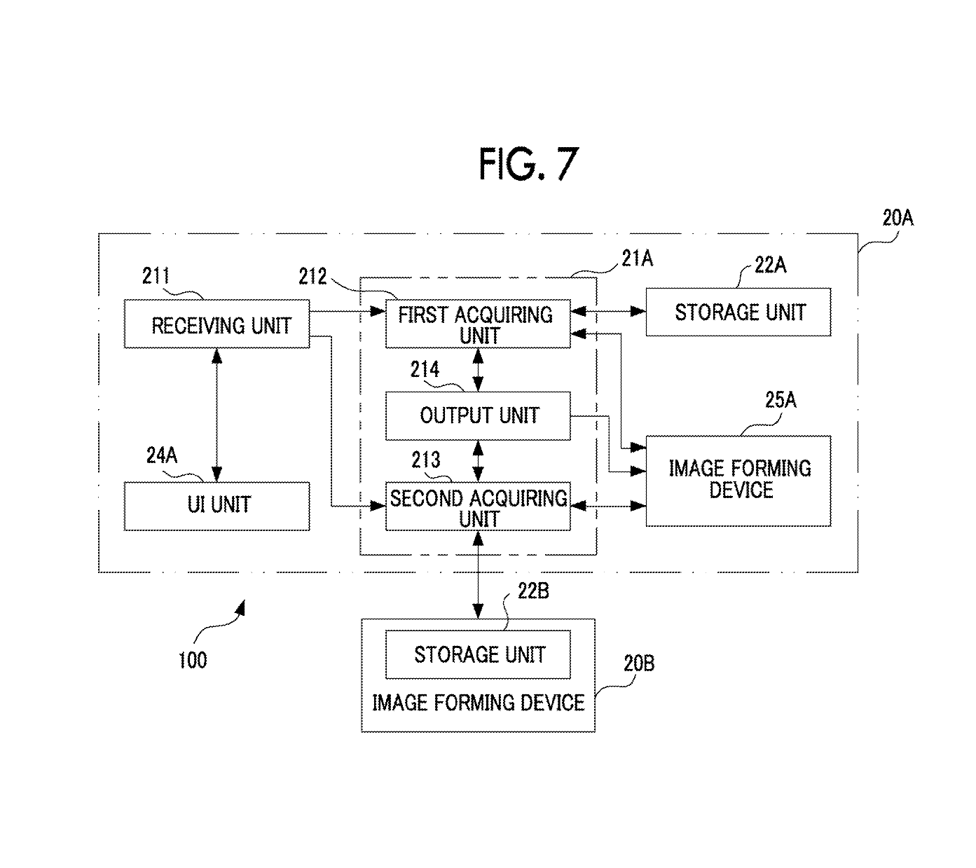

FIG. 7 is a block diagram illustrating the functional configuration of the image forming system 100. In FIG. 7, although the image forming devices are denoted by different reference numerals 20A and 20B in order to indicate two different image forming devices 20, the respective image forming devices are not limited to a specific image forming device 20. The storage unit 22A is an example of a storage unit that stores user identification information for identifying a user and image data that represents an image in correlation. A receiving unit 211 that is implemented by the cooperation of the control unit 21A and the UI unit 24A of the image forming device 20A is an example of a receiving unit that receives the input of the user identification information of any of the users. A first acquiring unit 212 that is implemented by the control unit 21A is an example of a first acquiring unit that acquires image data correlated with the user identification information received by the receiving unit from the storage unit 22A included in the subject device when the image data is stored in the storage unit 22A. A second acquiring unit 213 that is implemented by the control unit 21A is an example of a second acquiring unit that acquires image data which is correlated with the user identification information received by the receiving unit and which is stored in the storage unit 22B of another image forming device 20B when the first acquiring unit is unable to acquire the image data. The image forming unit 25A is an example of an image forming unit that forms an image corresponding to the image data acquired by the first acquiring unit or the second acquiring unit. An output unit 214 that is implemented by the control unit 21A is an example of an output unit that outputs the image data acquired by the first acquiring unit or the second acquiring unit to the image forming unit 25A that forms an image corresponding to the image data.

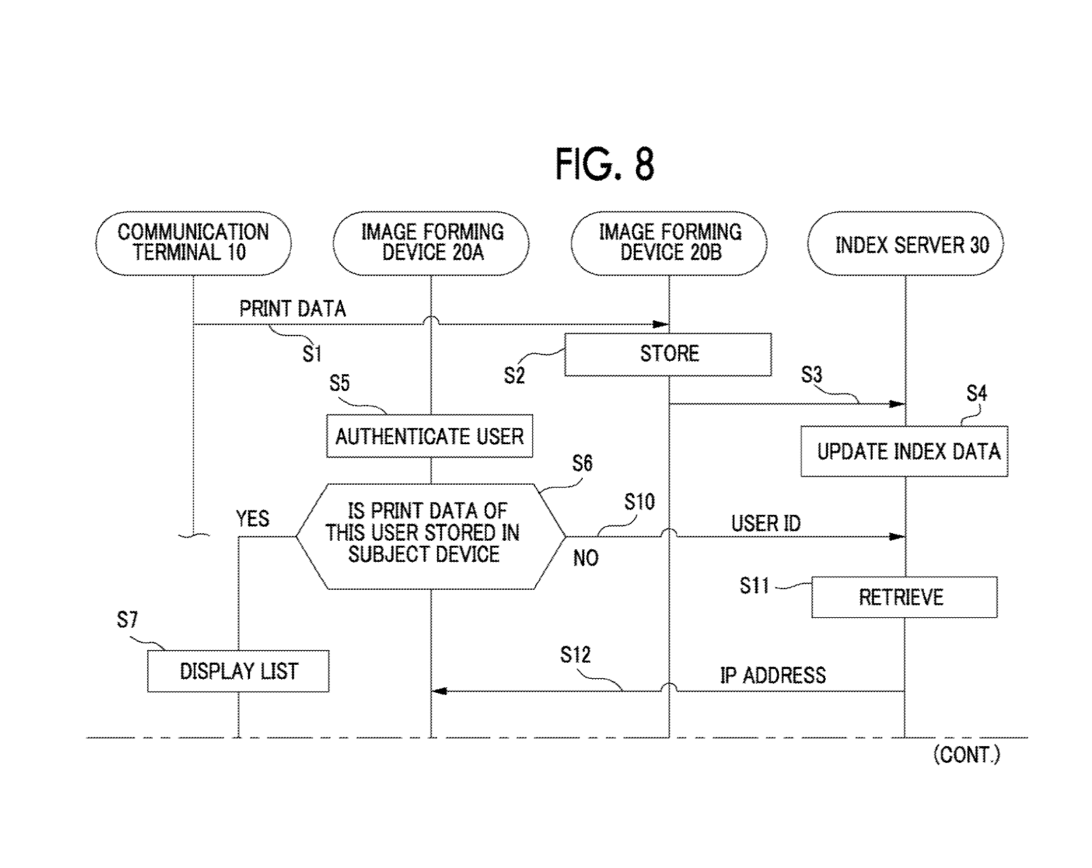

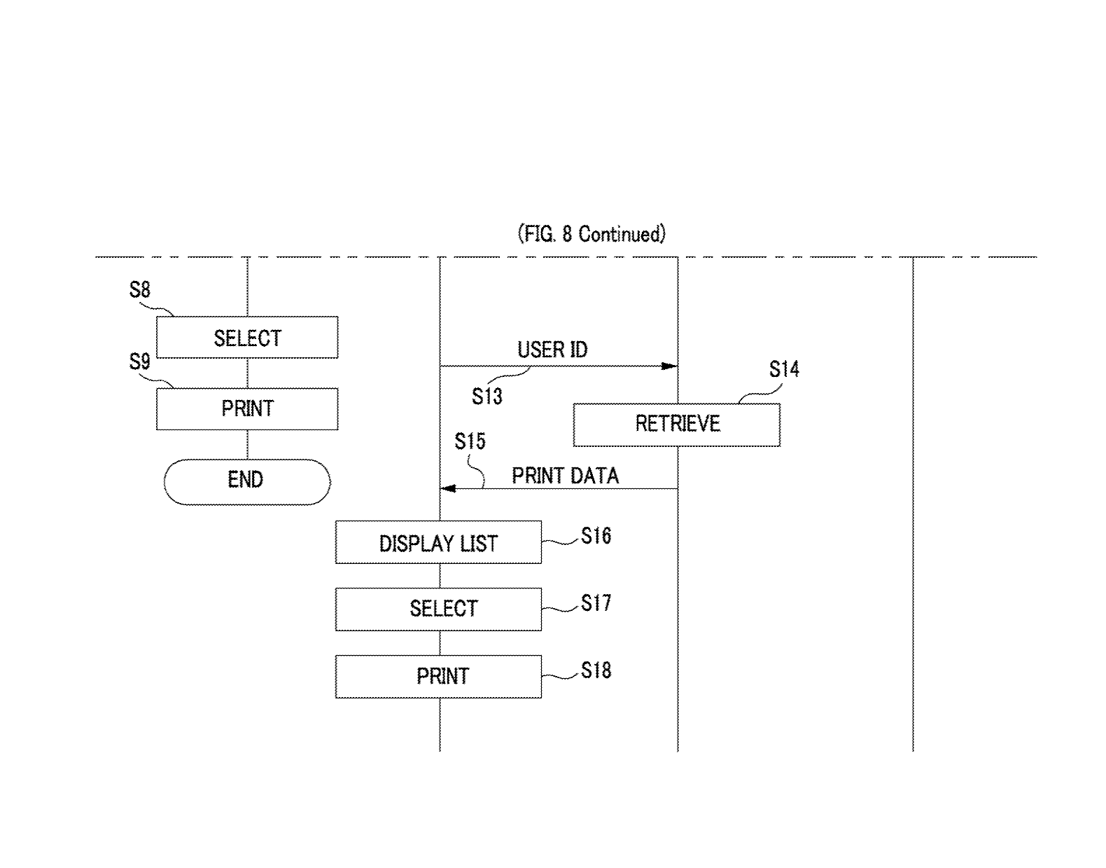

FIG. 8 is a sequence diagram illustrating the operation of the image forming system 100. In the description of FIG. 8, “user” means a user having a user ID of “User01.” First, when the user outputs a print instruction using the communication terminal 10, the control unit 11 of the communication terminal 10 transmits print data based on the instruction to the image forming device 20 indicated by the spooler information that is set to the printer driver 121 using the communication unit 13 (step S1). In this example, it is assumed that the transmission destination is the image forming device 20B. Upon receiving the print data, the control unit 21B of the image forming device 20B stores the received print data in the storage unit 22B as print data 221 (step S2). Moreover, the control unit 21B transmits the user ID included in the received print data, an IP address allocated to the subject device, and the name allocated to the subject device to the index server 30 using the communication unit 23 (step S3). Moreover, the control unit 31 of the index server 30 updates index data 321 based on the received content (step S4). Specifically, in step S4, the control unit 31 updates the storage destination IP address and the storage destination name of the index data 321 in accordance with the received content when the subject device and the storage destination name in the index data 321 correlated with the user ID included in the received content are different from the IP address and the device name included in the received content.

Subsequently, it is assumed that the user moves from the position of the communication terminal 10 to the position of the image forming device 20A and tries to execute printing based on the print data using the image forming device 20A. The user inputs a user ID and a password using the UI unit 24 and performs user authentication for the image forming device 20A (step S5). When user authentication is completed, the control unit 21A of the image forming device 20A determines whether the print data of the authenticated user is stored in the subject device (step S6). Specifically, in step S6, the control unit 21A determines whether the print data including the user ID authenticated in step S5 is stored in the storage unit 22A. When the print data 221 of the authenticated user is stored in the subject device (step S6: YES), the control unit 21A displays a list of the print data 221 on the touch screen using the UI unit 24A (step S7).

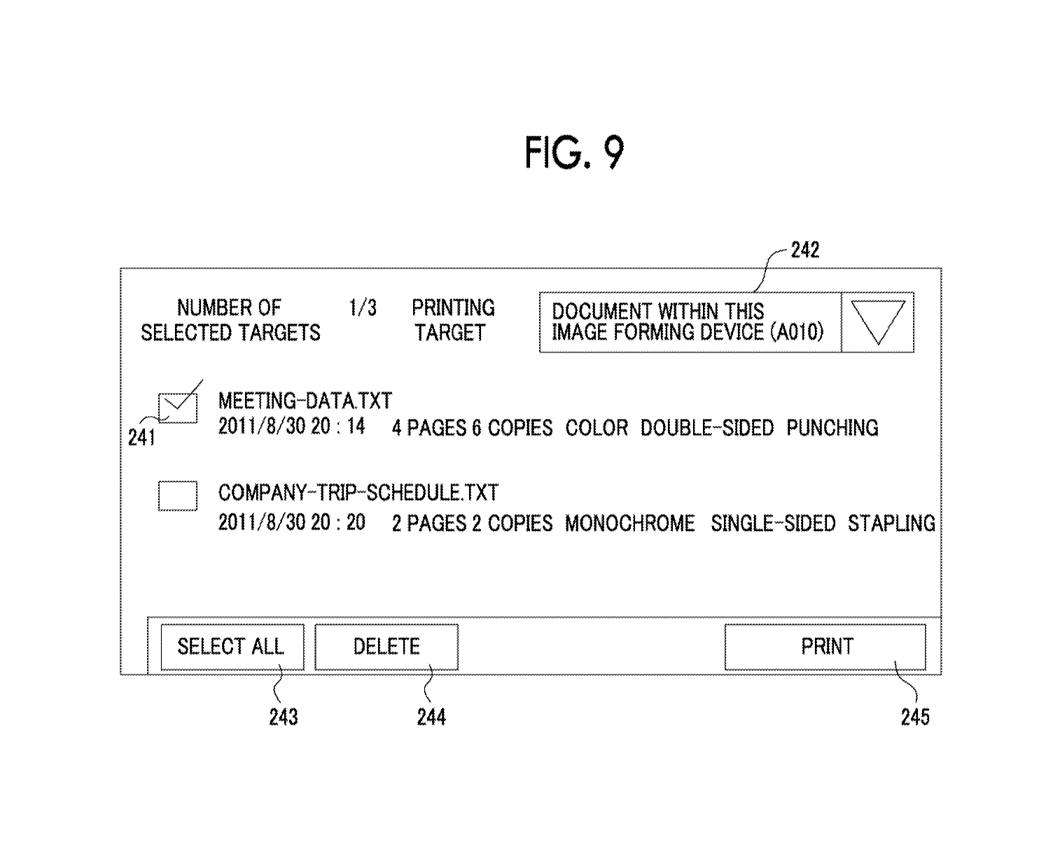

FIG. 9 is a diagram illustrating an example of the list of the print data 221 displayed on the touch screen of the image forming device 20A. The example of FIG. 9 illustrates a case where two print data, items 221 correlated with the user ID of the authenticated user are stored in the storage unit 22A of the image forming device 20A. The user checks a check box 241 of print data that is to be printed using the UI unit 24A. In a print target box 242, the name of the image forming device 20 in which the displayed print data is stored is displayed. The example of FIG. 9 illustrates that the displayed print data is stored in the image forming device 20A being operated by the user. The print target box 242 is a pull-down box. In a list displayed in a pull-down format, in addition to the name of the subject device, the storage destination name in the index data 321 correlated with the user ID of the authenticated user is displayed. The user may select a desired image forming device 20 from the list using the UI unit 24A. The control unit 21A displays print data stored in the storage unit 22 of the image forming device 20 selected in the print target box 242 in correlation with the user ID of the user on the touch screen.

When the user presses a select-all button 243 using the UI unit 24A, the control unit 21A displays all check boxes 241 in a checked state. Moreover, when the user designates print data and presses a delete button 244 using the UI unit 24A, the control unit 21A deletes the designated print data from the storage unit 22A. Further, when the user presses a print button 245 using the UI unit 24A, the control unit 21A prints the print data of which, the check box 241 is checked.

The description returns to FIG. 8. Subsequently to step S7, when the user checks the check box 241 of the print data that is to be printed using the UI unit 24A, the control unit 21A of the image forming device 20A selects the print data as a print target (step S8). Moreover, the control unit 21A executes printing based on the selected print data using the image forming unit 25A (step S9).

On the other hand, when the print data 221 of the authenticated user is not stored in the subject device (step S6: NO), the control unit 21A of the image forming device 20A transmits an instruction to perform retrieval using the user ID of the user as a key to the index server 30 using the communication unit 23A (step S10). Upon receiving the instruction, the control unit 31 of the index server 30 retrieves the index data 321 using the received user ID as a key and acquires the storage destination IP address and the storage destination name correlated with the user ID (step S11). In this example, since the user ID is “User01,” the control unit 31 acquires “192.168.227.101” and “A001” as the storage destination IP address and the storage destination name, respectively (see FIG. 6). Moreover, the control unit 31 transmits the user ID, the storage destination IP address, and the storage destination name to the image forming device 20A using the communication unit 33 (step S12).

Upon receiving the data, the control unit 21A transmits an instruction to retrieve the print data using the user ID of the authenticated user as a key to the image forming device 20B indicated by the received storage destination IP address using the communication unit 23A (step S13). Upon receiving the instruction, the control unit 21B of the image forming device 20B retrieves the print data 221 in the storage unit 22B using the received user ID as a key and acquires the print data correlated with the user ID (step S14). Moreover, the control unit 21B transmits the received user ID and the acquired print data to the image forming device 20A using the communication unit 23B (step S15). The control unit 21A displays a list of the print data received using the communication unit 23A on the touch screen using the UI unit 24A (step S16).

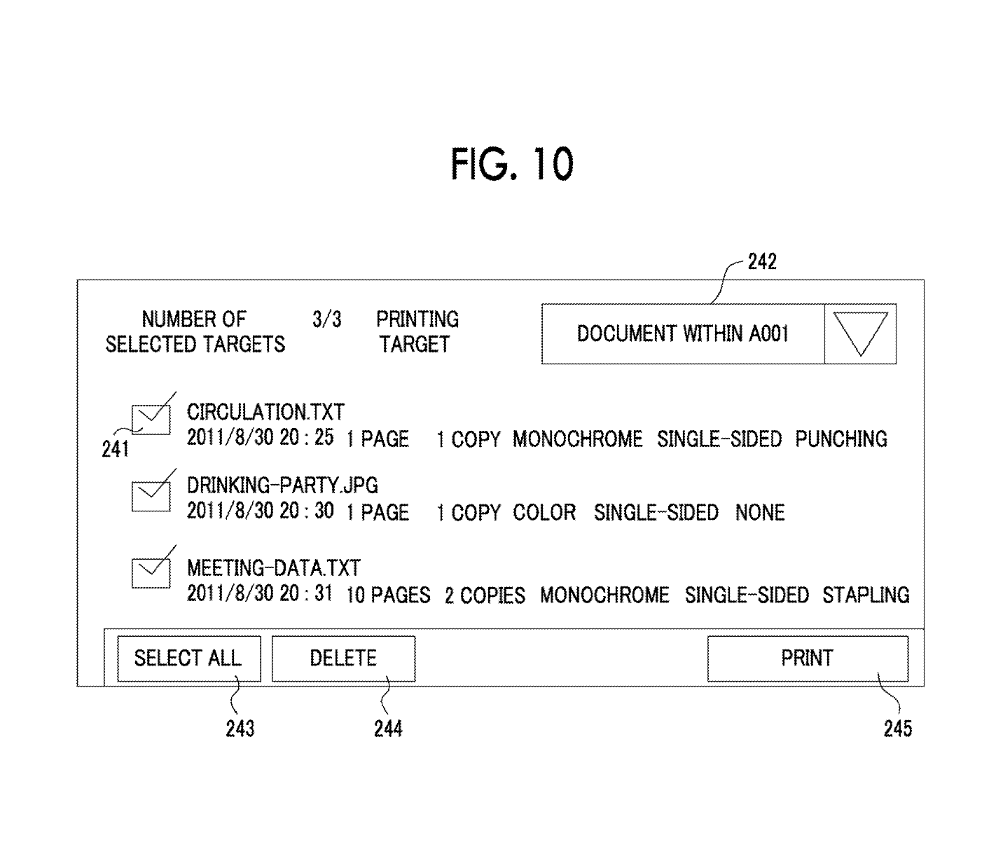

FIG. 10 is a diagram illustrating an example of the list of the print data displayed on the image forming device 20A. The example of FIG. 10 illustrates a case where three print data items 221 correlated with the user ID of the authenticated user are stored in the image forming device 20B.

The description returns to FIG. 8. Subsequently to step S15, the user checks the check box 241 of the print data that is to be printed using the UI unit 14, whereby the control unit 21 of the image forming device 20A selects the print data as a print target (step S17). Moreover, the control unit 21 of the image forming device 20A performs printing based on the selected print data using the image forming unit 25 (step S18).

According to this exemplary embodiment, when the print data of the user is not stored in the storage unit 22 of the subject device, the control unit 21 of the image forming device 20 transmits an instruction to retrieve the print data of the user to another image forming device 20. That is, when the print data of the user is stored in the storage unit 22 of the subject device, the control unit 21 does not transmit the retrieval instruction to the other image forming device 20. In general, it is considered that the user performs printing using the image forming device 20 which is set in the printer driver 121 as the spooler information. This is because the image forming device 20 which is frequently used by the user is set to the spooler information as the storage destination of the print data. For example, the image forming device 20 that is closest to the position of the user is set to the spooler information. The image forming device 20 is the image forming device 20B, for example. Since the spooler information is set in the printer driver 121, the print data, of the user is stored in the storage unit 22B of the image forming device 20B. That is, in such a case, when the user performs printing of print data using the image forming device 20B, since retrieval is not executed for the other image forming device 20, the time required for completing printing is shortened by that amount. Moreover, even when the print data of the user is not stored in the storage unit 22 of the image forming device 20 being operated by the user, the operation of the user is not required, and the control unit 21 of the image forming device 20 being operated acquires the print data from the other image forming device 20. Thus, it does not take time for the operation of the user.

Moreover, when the print data of the user is stored in the storage unit 22 of the subject device, the control unit 21 does not need to acquire the print data from the other image forming device 20 using the communication unit 23. Thus, printing may be performed without any problem even when a problem occurs in the network and communication is not possible. Therefore, in this case, since printing is performed even when the network problem is not solved, it is not necessary to wait until the problem is solved. Moreover, since the storage unit 32 of the index server 30 stores the index data 321, it is possible to lessen the burden for the control unit 21 of the image forming device 20 to specify the other image forming device 20 in which it is highly likely that the print data is stored in the storage unit 22 in correlation with the user ID of the authenticated user. Further, since information for identifying different image forming devices 20 is managed as the index data 321 in an integrated manner, the image forming device 20 may save resources required for managing the information.

As above, according to this exemplary embodiment, it is possible to shorten the time required for forming an image designated by the user using any image forming device among the plural image forming devices connected to the network as compared to a case which does not have a configuration in which when the print data of the user is not stored in the storage unit of the subject device, the print data of the user stored in the storage unit of another image forming device is acquired.

### MODIFICATION EXAMPLES

The above exemplary embodiment may be modified in the following manner. The following modification examples may be implemented in an appropriate combination.

### First Modification Example

The image forming device 20 that stores the print data displayed as a list may be determined when the user designates the IP address of a specific image forming device 20. In this example, it is assumed that the image forming device 20 being operated by the user is the image forming device 20A. In this case, the user inputs the IP address of the desired image forming device 20 in the input box displayed on the touch screen using the UI unit 24A. For example, the user inputs “192.168.227.102” as the IP address using the UI unit 24A. As illustrated in FIG. 6, the name of the image forming device 20 to which the IP address is allocated is “A002.” Moreover, the user presses a button for providing an instruction that designates the IP address using the UI unit 24A.

Upon receiving the instruction, the control unit 21A of the image forming device 20A transmits an instruction to retrieve the print data using the user ID of the user in operation as a key to the image forming device 20C indicated by the designated IP address using the communication unit 23A. The control unit 21C of the image forming device 20C retrieves the print data 221 using the received user ID as a key and acquires print data correlated with the user ID. Moreover, the control unit 21C transmits the list that represents the acquired print data to the image forming device 20A using the communication unit 23C. The control unit 21A displays the list of the print data on the touch screen using the UI unit 24A.

According to the first modification example, the user designates the image forming device 20 in which the desired print data is stored. Thus, even when there is a problem in the index server 30, for example, and it is not possible to retrieve the print data, the print data is acquired and printed.

### Second Modification Example

A method of acquiring the list of the print data stored in the image forming device 20 different from, the image forming device 20 being operated by the user is not limited to the method that uses the index server 30 as in the exemplary embodiment, but the following method may be used. For example, a case where the user having the user ID of “User01” operates the image forming device 20A will be considered. In this case, the control unit 21A of the image forming device 20A broadcasts an instruction to retrieve the print data using the user ID “User01” as a key to another image forming device 20 which is capable of being communicated with in the subnet mask, for example, at the timing of step S10 illustrated in FIG. 8. Upon receiving a response to the broadcast, the control unit 21A of the image forming device 20A displays the list of the received print data on the touch screen.

Here, when the response is received from plural image forming devices 20, the control unit 21A of the image forming device 20A displays the list including the print data having the latest stored date, for example, on the touch screen preferentially. The reason that the list including the print data having the latest stored date is displayed on the touch screen preferentially is because the newer the stored date, the shorter the time elapsed after that user transmits the print instruction using the communication terminal 10, that is, the higher the possibility of the print data being printed later. In this case, the names of the other image forming devices 20 which are not the transmission source of the list axe displayed in a pull-down list of the print target box 242. Moreover, when the response is received from plural image forming devices 20, the control unit 21A of the image forming device 20A may display all of the lists of the received print data received as the responses on the touch screen. The range of the other image forming devices 20 serving as the broadcast destination is not limited to those present within the subnet mask but may be determined in advance by the user.

According to the second modification example, since the index server 30 is not required, the configuration of the image forming system 10 becomes simpler than that of the exemplary embodiment. That is, it is possible to decrease the number of devices that constitute the image forming system 100 other than the image forming device 20.

### Third Modification Example

The list of the print data displayed on the touch screen is not limited to those stored in one image forming device 20, the print data stored in plural image forming devices 20 may be combined and displayed as a list. For example, a case where the print data correlated with the user ID “User01” is stored in both the image forming device 20A being operated by the user of the user ID “User01” and the image forming device 20B that is not being operated by the user will be considered. In this case, a display button for displaying the print data stored in the subject device and the other image forming devices 20 is displayed on top of the print target box 242 illustrated in FIG. 9, for example. Moreover, subsequently to step S7 of FIG. 6, when the user presses the display button using the UI unit 24A, the control unit 21A performs the same processes as those of steps S10 to S15. In this manner, the control unit 21A displays the list of the print data stored in the subject device and the list of the received print data on the touch screen together. After that, the processes subsequent to step S8 are performed.

In the third modification example, the print data correlated with the user ID of the authenticated user is stored in the subject device. Thus, when the print data is selected as print target data, it is not necessary to consume the time required for completing printing when the user executes printing based on the print data using the image forming device 20A. In contrast, in the third modification example, when the print data correlated with the user ID of the authenticated user is distributed and stored in plural image forming devices 20 including the subject device, the print data correlated with the user ID is combined and displayed as a list. Thus, the user may save the burden of checking the individual print data.

### Fourth Modification Example

Moreover, the present invention may be understood as a program for causing a computer to function as a control device. The program may be provided in a form of being recorded on a recording medium such as an optical disc and may be provided in a form of being downloaded to a computer via a communication network such as the Internet and installed and used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
a plurality of image forming devices that forms an image, wherein
each of the image forming devices includes:
a storage unit that stores user identification information for identifying users and image data that represents an image in correlation;
a receiving unit that receives an input of the user identification information of any of the users;
a first acquiring unit that acquires image data correlated with the user identification information received by the receiving unit from the storage unit included in the subject device when the image data is stored in the storage unit;
a second acquiring unit that acquires image data which is correlated with user identification information received by the receiving unit and which is stored in the storage unit included in another image forming device different from the subject device when the first acquiring unit is unable to acquire the image data; and
an image forming unit that forms an image corresponding to the image data acquired by the first acquiring unit or the second acquiring unit.

2. The image forming system according to claim 1, further comprising;
a management device that includes an identification information storage unit that stores device identification information for identifying the respective image forming devices and the user identification information in correlation, wherein
when the first acquiring unit is unable to acquire the image data, the second acquiring unit specifies device identification information stored in the identification information storage unit in correlation with the user identification information received by the receiving unit and acquires image data stored in correlation with the user identification information in the storage unit included in an image forming device identified by the device identification information.

3. The image forming system according to claim 1, wherein
when the first acquiring unit is unable to acquire image data, the second acquiring unit transmits a request for the image data stored in correlation with the user identification information received by the receiving unit, to an image forming device other than the subject device and acquires image data transmitted from the image forming device other than the subject device in response to the request.

4. An image forming device comprising:
a storage unit that stores user identification information for identifying users and image data that represents an image in correlation;
a receiving unit that receives an input of the user identification information of any of the users;
a first acquiring unit that acquires image data correlated with the user identification information received by the receiving unit from the storage unit included in the subject device when the image data is stored in the storage unit;
a second acquiring unit that acquires image data which is correlated with user identification information received by the receiving unit and which is stored in the storage unit included in another image forming device different from the subject device when the first acquiring unit is unable to acquire the image data; and
an image forming unit that forms an image corresponding to the image data acquired, by the first acquiring unit or the second acquiring unit.

5. A non-transitory computer readable medium storing a program for causing a computer to function as:
a storage unit that stores user identification information for identifying users and. image data that represents an image in correlation;
a receiving unit that receives an input of the user identification information of any of the users;
a first acquiring unit that acquires image data correlated with the user identification information received by the receiving unit from the storage unit included in the subject device when the image data is stored in the storage unit;
a second acquiring unit that acquires image data which is correlated with user identification information received by the receiving unit and which is stored in the storage unit included in another image forming device different from the subject device when the first acquiring unit is unable to acquire the image data; and
an output unit that outputs the image data acquired by the first acquiring unit or the second acquiring unit to an image forming unit that forms an image corresponding to the image data.

6. An image forming method comprising:
storing user identification information for identifying users and image data that represents an image in a storage unit in correlation;
receiving an input of the user identification information of any of the users;
firstly acquiring image data correlated with the received user identification information from the storage unit included in the subject image forming device when the image data is stored in the storage unit;
secondly acquiring image data which is correlated with the received user identification information and which is stored in the storage unit included in another image forming device different from the subject image forming device when it is not possible to acquire the image data in the first acquiring step; and
outputting the acquired image data to an image forming unit that forms an image corresponding to the image data.
